(19) United States
(12) Patent Application Publication
(10) Pub. No.: US 2006/0134255 A1
(43) Pub. Date: Jun. 22, 2006

(54) Variable drive marbleizing rotor

(76) Inventor: E. Gary Myers, Scottsdale, AZ (US)

Correspondence Address: Snell & Wilmer L.L.P., One Arizona Center, 400 East Van Buren, Phoenix, AZ, 85004-2202, US

(21) Appl. No.: 11/014,414

(22) Filed: Dec. 16, 2004

(51) Int. Cl. A21C 11/10

(52) U.S. Cl. 425/289

(57) ABSTRACT

A system and method for producing a marbleized soap product, wherein a marbleizing rotor within a soap plodder effectuates the manufacture of a marbleized soap product. In accordance with an exemplary embodiment, an exemplary soap marbleizing system and method comprises at least a primary soap plodder, a secondary soap plodder, a marbleizing rotor, and an extrusion nozzle. During production, the drive motor from at least one of each plodder and/or the marbleizing rotor may be a variable speed drive motor such that the degree of marbleization of the end soap product may be varied.

### FIELD OF INVENTION

The present invention generally relates to a soap-plodding system and method, more specifically, to a soap-plodding device for manufacturing a marbleized soap product.

### BACKGROUND OF THE INVENTION

Marbleized soaps are generally well known in the industry. These soaps have long been available and comprise, generally, a multi-colored and/or variably striated, soap product. Marbleized soaps may be desirable for any number of reasons. For example, a consumer may wish to display a somewhat less antiseptic looking item than a mere solid colored soap bar. It may be preferable by some consumers to obtain a soap bar that accentuates the decor of, for example, a bathroom. By offering a soap bar that exhibits a stylized marbling pattern, the consumer can enjoy the benefit of a softer style.

Alternatively, with regard to the cleaning properties of a specific manufactured soap, it may be desirous to incorporate various beneficial properties within the soap product. In other words, other than a marbleizing effect for aesthetic purposes, it may be desirable to incorporate abrasive cleansing particles, conditioners, moisturizers, and the like.

However, while marbleized soaps are generally well known in the prior art, there exist various anomalies in the bars, and systems and methods that produce them. For example, some prior art describe a system wherein, a colored dye is introduced into the soap product stream and subsequently mixed with the soap product. This type of marbleization, though, has a tendency to cause, “hot spots” or higher concentrations of color blotches. There is also a possibility for inconsistent marbling, wherein discrete areas of the soap bar exhibits more marbling effect than other parts of the soap bar.

Additionally, other disadvantages with prior art marbleizing exist. For example, some prior art systems use a static manifold incorporated in the extrusion nozzle which “imbeds” a second colored soap product into the primary soap product stream to produce a striated soap bar. However, often, the resulting product does not exhibit a homogeneous marbleizing pattern throughout the entire cross-section of the soap bar. Moreover, an “imbedded” secondary soap has a tendency to separate from the primary soap product over the useful life of the product.

An even further disadvantage to the prior art results from the inability to effectively control their marbleizing effect. In general, any introduced dyes or imbedded secondary soap streams are executed in a constant fashion, and therefore, the extent of the pattern is not controlled.

Thus, there exists a need for a marbleized soap that exhibits a more homogeneous marbleized pattern and not susceptible to separation between the mixed soap product. Furthermore, what is needed is a system and method for producing such a soap product, and a manner for controlling the extent of the marbleizing pattern.

### SUMMARY OF THE INVENTION

Briefly, the present invention is directed towards a marbleizing soap plodder. For example, the marbleizing soap plodder may comprise a primary plodder, a secondary plodder, and a marbleizing rotor to mix the soap from both plodders. In accordance with various embodiments of the present invention, motors for driving the various components, (e.g., the primary plodder, secondary plodder, and the marbleizing rotor) may have variable speed controls varying the amount of marbleization and ultimately the design of the marbleized soap.

### BRIEF DESCRIPTION OF THE DRAWINGS

The subject matter of the present invention is described in conjunction with the appended drawing figures, wherein like reference numerals designate like elements, and:

FIG. 1 is a block drawing illustrating exemplary elements of the present invention;

FIG. 2 is a side view of a soap plodder illustrating exemplary components of a marbleized soap system in accordance with an embodiment of the present invention;

FIG. 3 is the front view of an exemplary spider bearing support;

FIG. 4 is the front view of an exemplary marbleizing rotor; and

FIG. 5 is a flow chart comprising an exemplary method for producing a marbleized soap product in accordance with the present invention.

### DETAILED DESCRIPTION

The following descriptions are of exemplary embodiments of the invention only, and are not intended to limit the scope, applicability or configuration of the invention in any way. Rather, the following description is intended to provide a convenient illustration for implementing various embodiments of the invention. As will become apparent, various changes may be made in the function and arrangement of the elements described herein without departing from the spirit and scope of the invention. For example, though not specifically described, various configurations of soap plodders and various types of soaps and other aspects now known or as yet unknown in the art, may be understood to fall within the scope of the present invention.

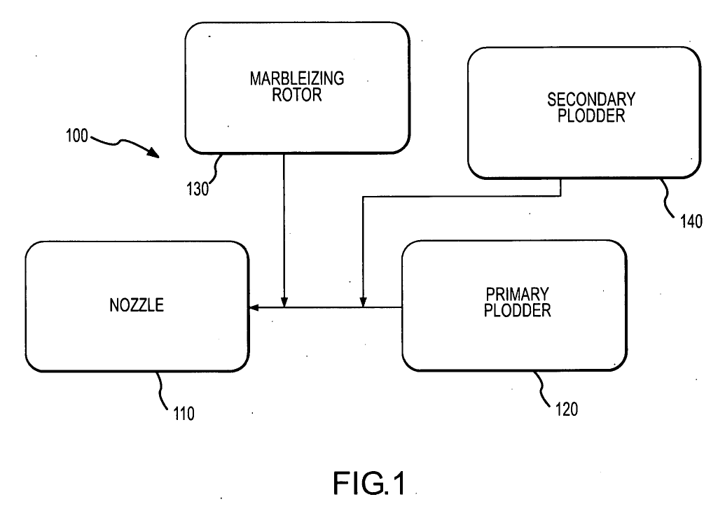

That said, in general, and in accordance with various embodiments of the present invention, with reference to FIG. 1, a system for manufacturing marbleized soap 100 comprises a primary plodder 120, a secondary plodder 140, a marbleizing rotor 130, and an extrusion nozzle 110.

In accordance with an exemplary embodiment of the present invention, primary plodder 120 and secondary plodder 140 introduce, in one example, two different colored soap products into extrusion nozzle 110. Marbleizing rotor 130, housed within extrusion nozzle 110, rotates to mix the two products and produces a marbleized soap for subsequent extrusion. In accordance with various aspects of the present invention and as described in greater detail below, marbleizing rotor 130 may be driven by a variable speed motor such that the extent of the marbleizing effect can be controlled.

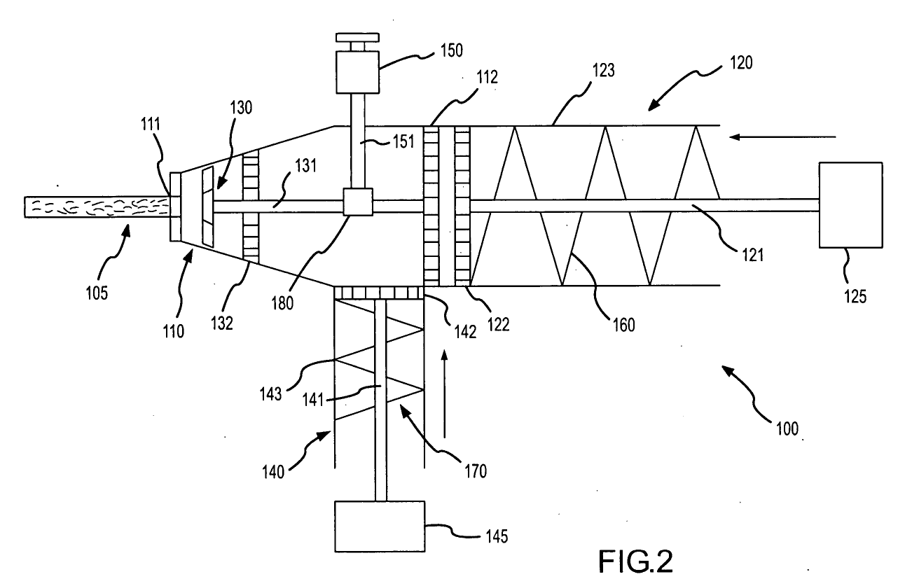

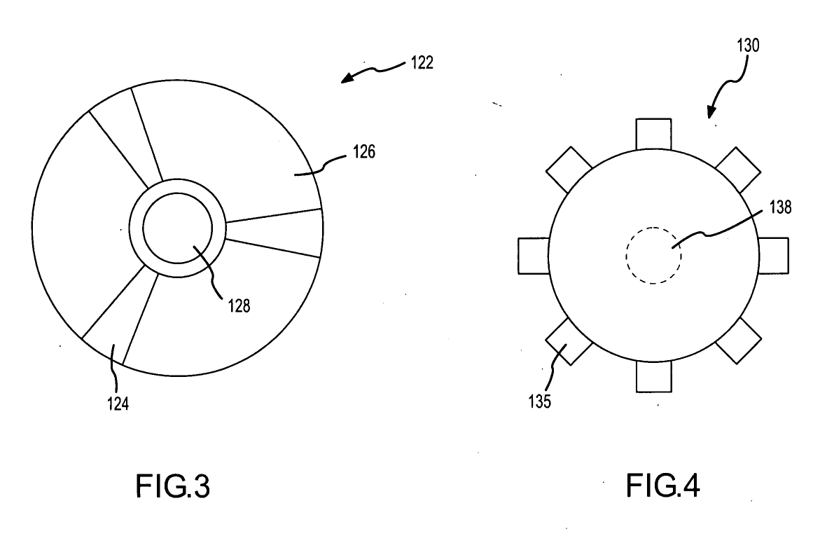

In accordance with an exemplary embodiment of the present invention, a soap plodder such as primary soap plodder 120 progresses an introduced soap product into extrusion nozzle 110 using various drive mechanisms. For example, an exemplary primary plodder 120 comprises a primary plodder housing 123, primary plodder drive shaft 121, primary spider bearing support 122, primary screw 160, and primary drive motor 125. With reference to the exemplary embodiment illustrated in FIG. 2, primary plodder housing 123 is provided to effectively contain the internal functional elements of primary soap plodder 120. Primary drive motor 125 connects to primary plodder drive shaft 121, which in turn is connected to screw 160 and facilitates rotation of primary screw 160. As primary screw 160 rotates, it advances the soap product along, through the device, ultimately towards extrusion nozzle 110. Primary drive shaft 121 is supported at one end opposite primary drive motor 125 to spider bearing support 122. Spider bearing support 122 is suitably configured to support primary drive shaft 121. For example, an exemplary configuration of spider bearing support 122 is illustrated in FIG. 3.

As mentioned above, a spider bearing support 122 supports primary drive shaft 121. With momentary reference to FIG. 3, an exemplary spider bearing support 122 comprises spider bearing brace 124, spider bearing opening 126, and spider bearing shaft connection 128. Spider bearing support 122 is affixed within plodder housing 123, and again, facilitates support of primary drive shaft 121. Spider bearing brace 124 is suitably configured to support and maintain the static positioning of spider bearing shaft connection 128. Spider bearing shaft connection 128 is suitably configured to accept one end of primary drive shaft 121, and shaft connection 128 comprises a bearing (not shown) that allows drive shaft 121 to rotate freely within. Spider bearing support 122 further comprises spider bearing opening 126, and this opening allows the advancing soap product to pass through towards extrusion nozzle 110. It should be appreciated that as the soap product advances past spider bearing support 122, spider bearing brace 124 effectuates a void in the advancing soap product stream, but such void will diminish as the soap product stream plastically deforms by the narrowing extrusion nozzle further downstream.

Returning to the detailed description of various embodiments of the present invention, marbleizing soap device 100 comprises secondary plodder 140. Secondary plodder 140 introduces a secondary soap product into extrusion nozzle 110 and comprises similar elements and operates in similar fashion as primary plodder 120 described above. For example, and with return reference to FIG. 2, secondary plodder 140 similarly comprises, secondary plodder housing 143, secondary plodder drive shaft 141, secondary spider bearing support 142, secondary screw 170, and secondary drive motor 145. Furthermore, secondary plodder 140, like primary plodder 120, may also comprise alternative components that may be substituted with comparable elements to perform similar functions as described herein that effectuate similar results.

In accordance with an exemplary embodiment of the present invention, with continuing reference to a typical soap plodder, for example primary plodder 120, it should be appreciated that various elemental components described may be substituted with comparable elements to perform similar functions as described herein, which effectuate similar results. For example, other components than primary screw 160 and/or primary drive shaft 121 may be used to effectively progress a soap product stream along the device, towards extrusion nozzle 110, components such as a conveyor system, a plunger system, a pressurized system, or similar components now known or as yet unknown in the art.

Further, in accordance with an exemplary embodiment of the present invention, primary drive motor 125 comprises a variable speed drive motor such that the rotational velocity of primary drive shaft 121 and thus, primary screw 160 may be varied. In this sense more operational control can be established in the soap manufacturing process. In yet another example, spider bearing support 122 may comprise other configurations that support and facilitate the rotation of drive shaft 121 yet still allow a soap product to progress along the device towards extrusion nozzle 110.

It should be appreciated that, while the detailed description herein describes an exemplary system and method for producing a marbleized soap product comprising a primary and secondary plodder, the present invention may comprise any number of plodders to produce an even greater marbleized soap product. For example, extrusion nozzle 110 may allow incoming soap product from a third, fourth, etc., soap plodder and suitably configured to create an even greater marbleized pattern.

Continuing with various embodiments of the present invention, marbleizing soap plodder 100 comprises extrusion nozzle 110. Extrusion nozzle 110 is suitably configured to accept incoming soap product streams from primary plodder 120 and secondary plodder 140 in addition to housing marbleizing rotor 130, which subsequently mixes the two soap product streams. In an exemplary embodiment, and with reference to FIG. 2, extrusion nozzle 110 comprises, extrusion nozzle die opening 111, nozzle spider bearing 112, marbleizing rotor spider bearing 132, marbleizing rotor 130, marbleizing rotor drive shaft 131, marbleizing motor drive shaft 151, and marbleizing rotor motor differential 180.

Continuing with an exemplary embodiment of the present invention, as briefly mention above, extrusion nozzle 110 comprises extrusion die opening 111. Extrusion die opening 111 comprises the dimensional opening with which the ultimate soap end product 105 is extruded. For example, in accordance with one aspect of the present invention, extrusion die opening 111 comprises a rectangular opening, such that a continuous soap bar is extruded and subsequently cut at discrete or indiscrete intervals into soap bars of conventional (or unconventional) size. Of course, one skilled in the art will appreciate that a variety of extrusion die openings may be utilized without detracting from the scope of the present invention. For example, a circular, oval, square, regular or irregular polygonal, and the like shaped extrusion die opening may be used.

In accordance with an exemplary embodiment of the present invention, extrusion nozzle 110 comprises nozzle spider bearing 112 and marbleizing rotor spider bearing 132. Again with momentary reference to FIG. 3, both spider bearings 112 and 132 are configured similarly and provide similar functions as spider bearing 122, described herein above. In addition, one should appreciate that spider bearings 112 and 132 may comprise a variety of configurations and yet maintain the functionality of the element.

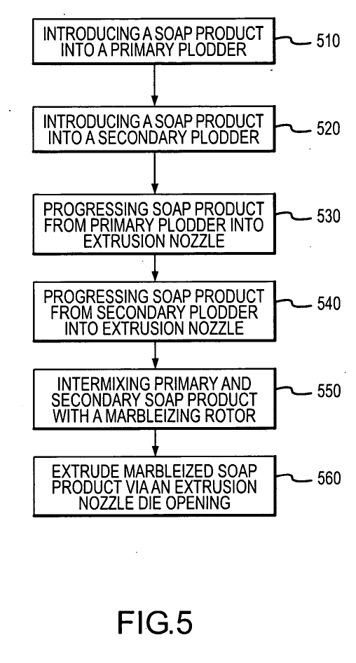

Further, as mentioned herein above and in accordance with various embodiments of the present invention, a system for producing a marbleized soap 100 comprises marbleizing rotor 130. Marbleizing rotor 130, housed within extrusion nozzle 110, mixes the incoming soap streams from primary soap plodder soap plodder 120 and secondary soap plodder 140. In one example, and with momentary reference to FIG. 4, marbleizing rotor 130 comprises, marbleizing rotor shaft connection 138 and marbleizing rotor flange 135. Marbleizing drive shaft 131 connects to marbleizing rotor 130 at marbleizing shaft connection 138. In accordance with one aspect of the present invention, marbleizing rotor flange 135 protrudes radially outward from the perimeter of marbleizing rotor 130 and effectuates the mixing of the soap products. However, it should be appreciated that marbleizing rotor flange 135 may comprise many configurations such that mixing of the soap product is effectuated. For example, the flange itself may comprise of several configurations, or the orientation and placement of the flange may vary.

Returning to FIG. 2, and an exemplary embodiment of the present invention, as soap product from primary plodder 120 and another soap product from secondary plodder 140 are advanced into extrusion nozzle 110, marbleizing rotor 130 rotates to mix the two soap products, facilitated by marbleizing rotor flange 135, extruded through extrusion die opening 111, and thus creating marbleized soap product 105.

Continuing in accordance with an exemplary embodiment of the present invention, marbleizing rotor 130 rotates via marbleizing rotor drive shaft 131. Marbleizing rotor drive shaft 131 is supported and suitably configured to rotate by spider bearings 132 and 112. Rotation of marbleizing rotor drive shaft 131 may be effectuated by a worm gear (not shown) within differential 180. Differential 180 translates the rotation of marbleizing rotor motor drive shaft 151 to marbleizing rotor drive shaft 131, wherein marbleizing rotor motor 150 drives marbleizing rotor motor drive shaft 151. In one aspect of the present invention, marbleizing rotor motor 150 comprises a variable speed motor such that the marbleizing effect of marbleizing rotor 130 may be varied and consequently the degree of marbleizing can be controlled.

With continued reference to FIG. 2, exemplary nozzle 110 diminishes in cross sectional opening, such that the soap product introduced in nozzle 110 may be plastically deformed and compressed until it is extruded at extrusion nozzle die opening 111. As shown in FIG. 2, the cross-sectional area of nozzle 110 decreases from where nozzle 110 connects to primary plodder housing 123 to extrusion nozzle die opening 111.

Additionally, various embodiments of the present invention may be utilized to mix other products besides merely different color soap products. For example, the present invention may be used to marbleize a soap and moisturizer product. In another example, a soap and conditioner may be mixed. In an extreme example, completely different products may be used such that a plodding device may manipulate them to form a marbleized product, such as other household goods, commercial goods, food stuffs, and the like.

In accordance with an exemplary embodiment of the present invention and with reference to FIG. 5, a flow chart depicting an exemplary method for producing a marbleized soap is shown. An exemplary method for producing a marbleized soap comprises the steps of introducing a soap product into a primary plodder 510 and introducing a soap product into a secondary plodder 520. Next, the soap product in the primary plodder is advanced towards the extrusion nozzle 530 and the soap product in the secondary plodder is likewise advanced towards the extrusion nozzle 540. Then the soap product from the primary plodder and the soap product from the secondary plodder are mixed via a marbleizing rotor to create a marbleized soap product 550, and finally, a marbleized soap product is extruded from extrusion nozzle die opening 560.

In accordance with another aspect of the present invention, step 550 comprises mixing the soap product from the primary and secondary plodder via the marbleizing rotor, wherein a variable speed drive motor effectuates the marbleizing rotor mixing speed. In accordance with yet another aspect of the present invention, at least one of primary screw 160 and secondary screw 170 may also vary their drive speed by a variable speed motor.

Finally, while the present invention sets forth a marbleizing soap product system and method, it should be appreciated that the foregoing description is of exemplary embodiments of the invention, and that the invention is not limited to the specific system and methods shown. That is, various modifications may be made in the design and arrangement of the elements set forth herein without departing from the scope of the invention. Moreover, while the embodiments are described, in connection with a specific marbleizing soap product system and method, it should be appreciated that these are merely exemplary of the type of marbleizing soap product systems and methods that may be used. Other marbleizing soap systems and methods not described herein, now known or hereinafter developed, may be used and still fall within the scope of the present invention.

What is claimed is:

1. A soap plodding system for producing a marbleized soap comprising;
a primary plodder, a secondary plodder, an extrusion nozzle, and a marbleizing rotor.

2. The system of claim 1, wherein said marbleizing rotor is controlled by a variable speed motor.

3. The system of claim 2, wherein at least one of said primary plodder and said secondary plodder is controlled by a variable speed motor.

4. The system of claim 1, wherein said marbleizing rotor may be located within said extrusion nozzle.

5. The system of claim 1, wherein said marbleizing rotor is controlled by a constant speed motor.

6. The system of claim 5, wherein one of said primary plodder or said secondary plodder is controlled by a variable speed motor.

7. The system of claim 1, wherein said marbleizing rotor comprises at least two protrusions extending radially from the perimeter of said marbleizing rotor.

8. The system of claim 1, wherein said marbleizing rotor comprises at least two openings within said marbleizing rotor.

9. A system for producing a marbleized soap comprising;
a first plodder comprising a first rotating screw to advance a first soap product towards an extrusion nozzle;
a second plodder comprising a second rotating screw to advance a second soap product towards said extrusion nozzle;
a first motor connected to said first rotating screw of said first plodder to control said first rotating screw speed;
a second motor connected to said second rotating screw of said second plodder to control said second rotating screw speed;
a marbleizing rotor within said extrusion nozzle for mixing said first soap product with said second soap product; and
a variable speed marbleizing motor connected to said marbleizing rotor to vary the speed of said marbleizing rotor.

10. A method for producing a marbleized soap comprising the steps;
introducing a first soap product into a primary plodder;
introducing a second soap product into a secondary plodder;
progressing said first soap product from said primary plodder into an extrusion nozzle;
progressing said second soap product from said secondary plodder into said extrusion nozzle;
mixing said primary soap product and said secondary soap product via a marbleizing rotor to produce a marbleized soap product; and
extruding said marbleized soap product via an extrusion nozzle die opening.
